(19) United States
(12) Patent Application Publication
(10) Pub. No.: US 2005/0055624 A1
(43) Pub. Date: Mar. 10, 2005

(54) Method, system, and computer-readable medium for creating electronic literary works, including works produced therefrom

(76) Inventors: Edward Seeman, Arvada, CO (US); Mike McGuffee, Arvada, CO (US); Mark Condon, Louisville, KY (US); Mark Weiser, Stillwater, OK (US); Brad Hutchings, Lake Forest, CA (US)

Correspondence Address: TIMOTHY J MARTIN, PC, 9250 W 5TH AVENUE, SUITE 200, LAKEWOOD, CO, 80226, US

(21) Appl. No.: 10/828,517

(22) Filed: Apr. 19, 2004

Related U.S. Application Data
(60) Provisional application No. 60/463,916, filed on Apr. 17, 2003.

(51) Int. Cl. G06F 17/60

(52) U.S. Cl. 715/500

(57) ABSTRACT

A computerized method, a computer-readable medium, and a system each pertain to the creation of an electronic literary work on a computer system. According to a representative methodology, a first working area of an application program is populated with selected digital images from an archive image set, to generate a contact sheet view comprising an imported image set. A second working area is populated with selected images from the imported image set to establish a working image set which is arrange into a selected storyboard sequence. Respective image data is associated with at least some of the digital images within the working set to define pairs of companion image items which are then displayed according to the storyboard sequence. An electronic literary work produced according to such a methodology is also provided.

### BACKGROUND OF THE INVENTION

The present invention broadly relates to the creation of literary content, and more particularly concerns software development tool for enabling individuals to develop personalized literary works, in the form of digital books with images and text, that can be printed by conventional means or disseminated electronically.

Literary works have and continue to be a cornerstone of civilizations. For centuries, and until only recently, literary works have been mass produced and circulated in a tangible book form using paper as the literary medium. However, recent and rapid innovations in computer technology and the Internet have enabled literary works to be made available in a digital form, such as e-books (Electronic-BOOKS), whereby text is presented on a computerized medium, such as a desktop computer, notebook computer or even a hand-held PDA. These digital data readers and electronic books somewhat emulate the attributes of a printed book and endeavor to present the reader with a visual appearance which is akin to that of traditional printed materials.

Modern day advances in technology have exposed individuals to unprecedented access to information and technology whereby creativity can be fostered at a much earlier age. In this regard, computerized innovations have enabled members of society to, in essence, become self-publishers by enabling them to create things that can be rapidly reproduced or disseminated over a communication interface such as the internet or through conventional techniques.

One adaptation of existing technology, which has been particularly suited to students and teachers across all grade levels for creating and publishing digital books is described in “Real ePublishing, REALLY PUBLISHING!” by Mark W. F. Condon and Michael McGuffee, 2001. This technique promotes literacy by combining the attributes of word processing templates, digital photography and conventional printing techniques so that students can use their reading, writing and computer skills to create personalized books, known as “webbes” (web books for everyone). Matching meaningful text with digital images, these e-publications are a means for students to celebrate and document activities of their everyday lives. These compositions, which can be produced in multiple languages, invite writers from every ethnicity, social class and language group in a school to see publication as a natural part of literacy learning and its compliment to developing content concepts.

The webbe creation process, as more thoroughly described in the above publication, generally involves the following steps. A digital camera is used to take pictures, and the software accompanying the camera is used to create a contact sheet from these pictures. A storyboard is then created utilizing a template that is either a piece of paper or a word processing template generated through the use of a word processor's “table” function. A manuscript may then be written for the work, after which the manuscript and the pictures are combined into a printing template, such as may be created using conventional word processing commands such as “table” and “textboxes”. Following creation of the cover pages and the title page, the printing template is printed and the individual pages are cut, collated and bound together to finish the webbe.

While the webbe concept has achieved increasing success and popularity in recent years, its versatility has been somewhat strained due to the disjoined nature of the various components, i.e., the contact sheet which is camera-dependent, and the storyboard and printing templates which do not provide a great deal of image and text editing capabilities. Thus, although webbe creation to date has been well received and is quite appealing, particularly to youth, the lack of integration and versatility among the various components can at times frustrate the creation process. Accordingly, it is desirable to expand upon this underlying technology to fulfill the need of producing a more integrated software tool which can produce digital books in a manner which is more efficient, user-friendly and versatile. The present invention is particularly directed to meeting these needs.

### BRIEF SUMMARY OF THE INVENTION

It is an object of the present invention to provide a new and improved computerized methodology for producing electronic literary works.

Another object of the present invention is to provide a software development tool, which can be stored on an appropriate computer-readable medium, to enable individuals to create electronic literary works.

A further object of the present invention is to provide literary works, in either tangible or electronic form, which are the end product of such a computerized methodology.

A still further object of the present invention is to provide such a methodology and software development tool which is more user friendly and versatile compared to previously employed techniques.

It is another object of the present invention to provide a new and improved system for enabling the creation and viewing of electronic literary works, preferably in the form of e-books, as well as a graphical user interface for use with such a system.

Yet another object of the present invention is to provide such a methodology, system, GUI and computer-readable medium which is particularly suited as an educational tool for permitting youth, such as school children, to publish their own literary works, thereby fostering creativity at a young age.

In its various forms, the present invention provides computerized methodologies, systems, and a computer-readable medium for use in enabling the creation and viewing of electronic literary works. The present invention also relates to an electronic literary work which, itself, is created according to one of the computerized method embodiments.

One embodiment of the computerized method is for creating an electronic literary work on a computer system that includes a display. According to this computerized method, an archive image set is provided which includes a plurality of digital images. A first working area of an application program is populated with selected digital images from the archive image set, thereby to generate a contact sheet view comprising an imported image set. The imported image set is, thus, derived from the archive image set. A second working area of the application program is populated with selected digital images from the imported image set, thereby establishing a working image set. Those digital images comprising the working image set are arranged into a selected storyboard sequence in either the first or second working areas, and image data is respectively associated with at least some of them to define pairs of companion image items. The pairs of companion image items are then displayed on the display according to the storyboard sequence. The computer-readable medium of the present invention has executable instructions for performing a method in accordance with the above. The present invention further provides an electronic literary work which is produced in accordance with such a method.

The archive image set may be stored either locally or on a remote computer system that it is accessible through a suitable communications interface. In preferred embodiments, the first and second working areas are different windows of a common application program. It is also preferred that the pairs of companion image items be displayed in a manner which resembles an e-book in an effort to present the user with a reading experience simulating that encountered when reading a tactile bound book. To this end, it is also preferred to associate a page number to each item within the pairs of companion image items, thereby to generate a numerical page sequence which chronologically corresponds to the selected storyboard sequence. Advantageously, the respective image data which can be associated with, or specifically correlated to, the digital images may be text-only data, non-text data or a mixture thereof. Further, the non-text data may be graphic images, photographic images, video images or a mixture of the same.

In preferred embodiments of the invention described herein, the imported image set which populates the first working area of the application program is the same as the working image set populating the second working area, and the digital images within these respective sets are the same. Also in the preferred embodiments, there is commonality between the images within the archive image set and the imported image set. Such capabilities, however, are preferential and not required. Preferred also is the association of respective image data with each of the digital images in the working image set, and the generation of a front and back cover for the electronic literary work by utilizing at least one selected digital image from the archive image set.

Another embodiment of the computerized method of the invention broadly comprises obtaining a plurality of digital images, storing them on a storage device as an image set, importing the image set into a working project area of a display device, thereby to populate the working project area with the digital images, and arranging them into a selected contact sheet sequence. Respective image data is then correlated with each of the digital images, thereby to define pairs of companion image items which are arranged into a selected storyboard sequence whereby they may be selectively displayed according to the selected storyboard sequence.

Certain embodiments for the systems contemplated by the present invention comprise storage capabilities for storing a plurality of digital images as an archive image set, display capabilities, output capabilities, and programmed processing capabilities for accomplishing methodologies in accordance with the above aspects. Another embodiment of a system for enabling creation and viewing of electronic literary work broadly comprises a composition component, a storage component, and a viewing component. The composition component is for creating the electronic literary work and includes editing capabilities which permit user-defined image data to be respectively associated with each of a plurality of digital images, thereby to define pairs of companion image items which may be arranged according to a selected storyboard sequence. The storage component stores an archive set of digital images for retrieval by the composition component, and the viewing component enables the electronic literary work created by the composition component to be viewed according to the selected storyboard sequence.

The composition component and the storage component may reside on common or different computer systems. Where the composition and storage components reside on a common computer system they are preferably part of a common application program. Where they are remote from one another, the system includes a suitable communications interface for providing access to the storage component. It is additionally contemplated that each of the composition, storage and viewing components may be at a distinct, remote location from one another, with suitable communications interfaces enabling data transmission therebetween.

Still another embodiment of a computer system according to the present invention has a graphical user interface including a display and a selection device. In this computer system, a method of preparing an electronic literary work via a composition menu on the display is provided. According to this method a set of entries for the composition menu are retrieved, each corresponding to a selected development stage during preparation of the electronic literary work. A first composition menu entry selection signal is received that is indicative of the selection device pointing at a first menu entry within the composition menu which corresponds to a contact sheet stage of development. In response to this first composition menu entry selection signal, a first working area of the display may be populated with a contact sheet view of digital images. The method also comprises receipt of a second composition menu entry selection signal that is indicative of the selection device pointing at a second menu entry from the composition menu that corresponds to a storyboard stage of development. In response to this second signal, a second working area of the display is populated with a storyboard view of digital images, whereby the storyboard view displays the digital images according to a selected storyboard sequence.

The method also contemplates receipt of third and fourth menu entry selection signals. The third menu entry selection signal is indicative of the selection device pointing at a third menu entry which corresponds to page editing. In response to this signal, a selected pair of adjacent pages from the storyboard view are displayed. Receipt of the fourth menu entry selection signal indicates the selection device pointing at fourth menu entry corresponding to image editing. In response to this fourth signal, a selected image is displayed so that it may be edited.

These and other objects of the present invention will become more readily appreciated and understood from a consideration of the following detailed description of the exemplary embodiments of the present invention when taken together with the accompanying drawings, in which:

### BRIEF DESCRIPTION OF THE DRAWINGS

FIG. 1 illustrates a diagram of an exemplary general purpose computer system that may be configured to implement aspects of the present invention;

FIG. 2 represents a high level diagrammatic view of a first exemplary embodiment of a system for enabling creation and viewing of an electronic literary work;

FIG. 3 is a screenshot showing the main project window for an application program which integrates the composition and viewing components of the present invention;

FIGS. 4(a)-4(b) are screenshots of dialog windows for setting and adjusting various options available within the application program;

FIGS. 5(a)-5(e) are each a respective screenshot showing various capabilities available upon selection of the application program's contact sheet tab in FIG. 3;

FIG. 6 is a screenshot showing various capabilities available upon selection of the application program's storyboard tab in FIG. 3;

FIG. 7 is a respective screenshot showing various capabilities available upon selection of the application program's composer tab in FIG. 3;

FIGS. 8(a)-8(c) are each a respective screenshot showing various capabilities available upon selection of the application program's image editor tab in FIG. 3;

FIGS. 9(a)-9(d) are each a respective screenshot showing various capabilities available upon selection of the application program's output tab in FIG. 3;

FIGS. 10 is a screenshot illustrating representative e-book pages generated by the viewing component which correspond to the storyboard viewing sequence of FIG. 6; and

FIGS. 11 and 12 each represent a high level flowchart for computer software which implements functions according to the present invention.

### DETAILED DESCRIPTION OF THE INVENTION

### A. Introduction

In accordance with these objectives the present invention, in one sense, relates to a software program to permit individuals to create and publish literary works, in the form of digital books with images and/or text, that can be printed by conventional means, viewed on an appropriate display or disseminated electronically. To this end, the present invention also contemplates a methodology for creating such digital books, referred to as e-books, as well as the literary content produced therefrom.

In the following detailed description, reference is made to the accompanying drawings which form a part hereof, and in which is shown by way of illustrations specific embodiments for practicing the invention. The leading digit(s) of the reference numbers in the figures usually correlate to the figure number; one notable exception is that identical components which appear in multiple figures are identified by the same reference numbers. The embodiments illustrated by the figures are described in sufficient detail to enable those skilled in the art to practice the invention, and it is to be understood that other embodiments may be utilized and changes may be made without departing from the spirit and scope of the present invention. The following detailed description is, therefore, not to be taken in a limiting sense, and the scope of the present invention is defined by the appended claims.

Various terms are used throughout the description and the claims which should have conventional meanings to those with a pertinent understanding of computer systems in general, and Windows® applications in particular. However, while the description to follow may entail terminology which is perhaps tailored to certain operating system platforms or programming environments, the ordinarily skilled artisan will appreciate that such terminology is employed in a descriptive sense and not a limiting sense. Where a confined meaning of a term is intended, it will be explicitly set forth or otherwise apparent from the disclosure.

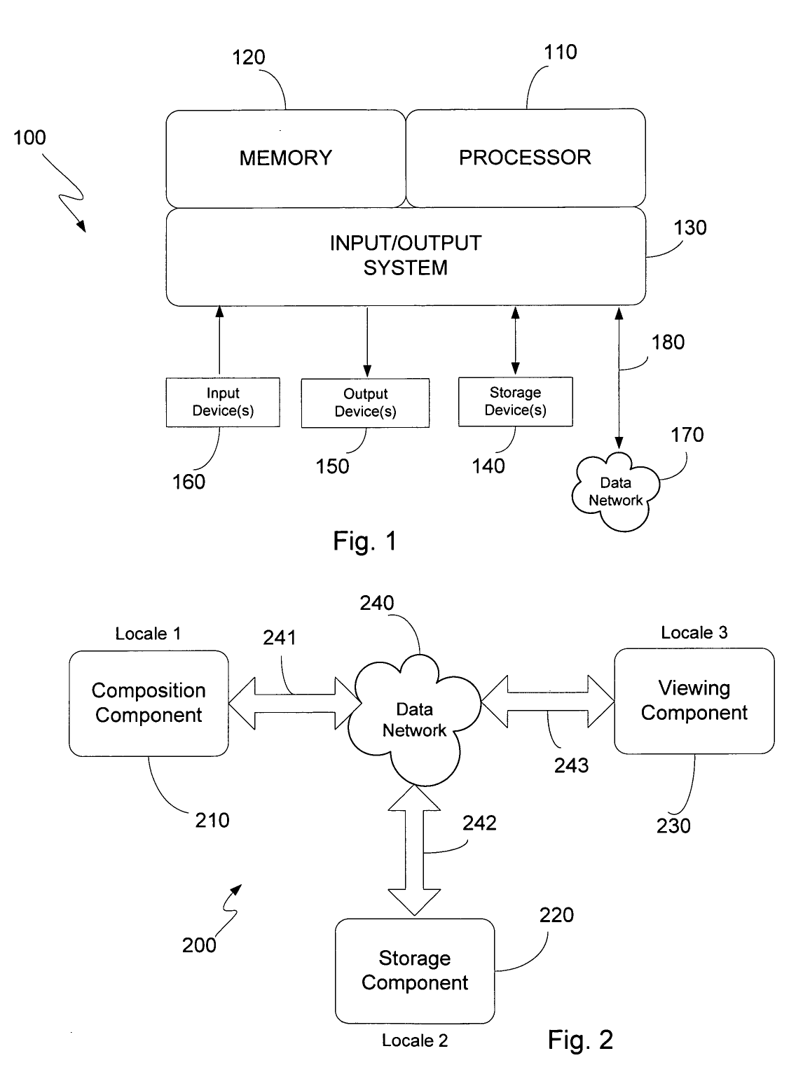

Aspects of the present invention may be implemented on a user's computer 100, such as shown in FIG. 1. More particularly, the general purpose computer 100 may be used to execute applications comprising computerized systems constructed in accordance with the present invention, and may be adapted to execute in any of the well-known operating system environments, such as MS-DOS, PC-DOS, OS2, UNIX, MAC-OS and WINDOWS, or other operating systems.

Computer system 100 comprises a central processing unit (CPU) 110, a memory 120 and an I/O system 130. The memory may include volatile memory such as static or dynamic RAM and non-volatile memory such as ROMs, PROMs, EPROMs. Various types of storage devices 140 can be provided as more permanent storage areas. Such devices may be a permanent storage device such as a large-capacity hard disk drive, or a removable storage device such as a floppy disk drive, a CD-ROM drive, a DVD-ROM drive, flash memory, a magnetic tape medium, or the like. Remote storage over a network is also contemplated. One or more of the memory or storage regions may contain programming code capable of configuring the computer system 100 to embody aspects of the present invention. The present invention, thus, encompasses program storage on an appropriate computer-readable medium, such as RAM, ROM, a disk drive, or the like and which is executable by processor 110, thereby to form an exemplary system. The I/O system 130 may operate with various input and output devices, 150 & 160 respectively, such as a keyboard, a display, a pointing device, etc. It may also operate with a data network 170 via a suitable communications link 180. The data network 170 may comprise a portion of the Internet, although other public or private networks may be used, such that the invention contemplates any suitable network infrastructure for accomplishing the teachings herein. Further, the data network may utilize either the TCP/IP protocols or other suitable public or proprietary communications and/or security protocols.

Although certain aspects of a computer system may be preferred in the illustrative embodiments, the present invention should not be unduly limited as to the type of computer on which it runs, and it should be readily understood that the present invention indeed contemplates use in conjunction with any appropriate information processing device, such as a general-purpose PC, a PDA, network device or the like, which has the capability of being configured in a manner for accommodating the invention. Moreover, it should be recognized that the invention could be adapted for use on computers other than general purpose computers, as well as on general purpose computers without conventional operating systems.

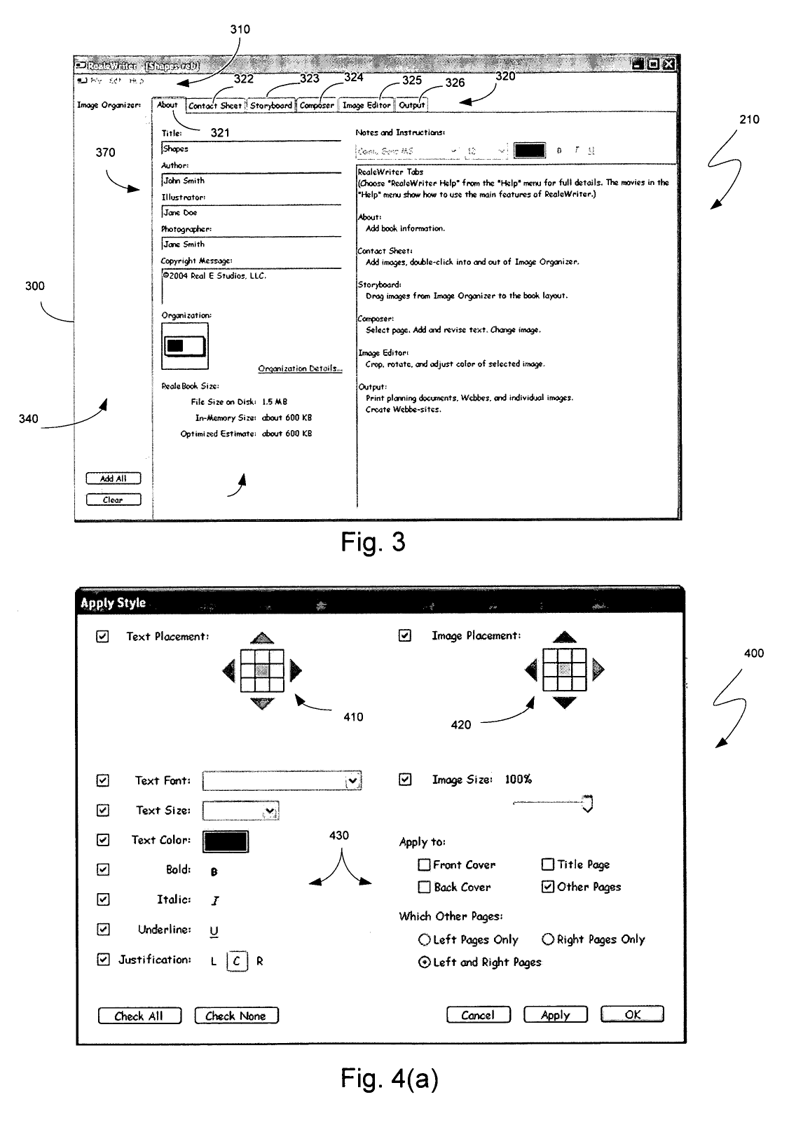

FIG. 2, for example, shows one exemplary embodiment of a system 200 for enabling creation and viewing of an electronic literary work. System 200 comprises three components, namely, a composition component 210, a storage component 220 and a viewing component 230. Composition component 210 resides at first locale 1 and is used to create the electronic literary work. As will be appreciated in the description to follow, composition component 210 can include editing capabilities which permit user-defined image data to be respectively associated with digital images, thereby to define companion image items which are arranged according to a selected storyboard sequence. Storage component 220 resides at another location, referred to as locale 2 and stores an archive set of digitally images for retrieval by composition component 210. Viewing component 230 may reside at yet another location, referred to as locale 3, and enables the electronic literary work created by composition component 210 to be viewed according to the storyboard sequence.

It can be appreciated from FIG. 2 that, where each of the various components 210, 220 and 230 is located at a respective distinct location that is remote from the others, they may communicate which each other along a data network 240 via respective communication interfaces 241-243. Further, each of the components 210, 220 and 230 may be stored on an appropriate computer system, such as computer system 100 above in FIG. 1.

A representative example of how a system such as 200 might be employed if through the use of a website which hosts a variety of digital image templates for all to use. The server(s) which hosts the website, thus, is the storage component 220. Various users who have obtained a respective composition component 210, such as by downloading an appropriate installer from the website, can then remotely access the storage component 220 and download a desired image set for creation of the electronic literary work. Once the work has been completed by a user(s) of composition component 210 it can then be transmitted in an appropriate format to others who have obtained an installer for at least the viewing component 230, so that the work can be viewed in an electronic book format. Of course, the ordinarily skilled artisan will appreciate that each of these three components 210, 220 and 230 can reside on a single computer system. Further, any two of them could reside on one computer system, while a third resides on another. Thus, the figures are only illustrative.

The source code for the software was developed on a machine running a Mac OS X utilizing the REALbasic 5.5 IDE available from REAL Software, Inc. of Austin, Tex. An explanation of the REALbasic programming language is beyond the scope of this document and the reader is assumed to be either conversant in this, or other suitable programming languages. This REALbasic development environment incorporates its own compiler and is adapted for developing standalone applications, for example, for use in a variety of OS environments such as Mac OSX, Mac OS 8-9 (Classic), Windows® 98/ME/NT/2000/XP and Linux /x86. The software also utilizes a plugin for REALbasic called “Component X Graphic” (CXG) developed by Hutchings Software, and version 3.2 of CXG is currently available at their website hutchings-software.com. CXG provides powerful, cross-platform, pixel-consistent, scalable graphics routines that extend REALbasic's picture class. It contains routines to stretch, flip, rotate, shear, and trim pictures, routines to adjust contrast, gamma, HSV, and RGB of pictures, and routines for compositing, threshold, transitions, and pixelating images.

It should be recognized by the artisan, however, that the concepts described herein could be readily ported to other OS environments using different development tools. Indeed, the programming could be developed using several widely available programming languages with the software component(s) coded as subroutines, sub-systems, or objects depending on the language chosen. In addition, various low-level languages or assembly languages could be used to provide the syntax for organizing the programming instructions so that they are executable in accordance with the description to follow. Thus, the preferred development tools utilized by the inventors should not be interpreted to limit the environment of the present invention.

Software embodying the present invention may be distributed in known manners, such as on computer-readable medium which contains the executable instructions for performing the methodologies discussed herein. Alternatively, the software may be distributed over an appropriate communications interface so that it can be installed on the user's computer system. Furthermore, alternate embodiments which implement the invention in hardware, firmware or a combination of both hardware and firmware, as well as distributing the modules and/or the data in a different fashion will be apparent to those skilled in the art. It should, thus, be understood that the description to follow is intended to be illustrative and not restrictive, and that many other embodiments will be apparent to those of skill in the art upon reviewing the description.

A web-based version which incorporates features of the present invention is also contemplated and can be accessible through any appropriate web browser and Internet connection. This implementation incorporates additional novel methodologies to enable efficient creation and dissemination of digital literary works. These online books, referred to as “RealeBooks” and are created dynamically as they are read, rather than the entire content existing in a single file which is sent to a reader. The initial version was developed on a Unix system using PHP, JavaScript, and MySQL.

Textual book content and structure is stored in a relational database along with all other literary works on the same system. Images that appear in a book are stored as files on a server and are referenced via text entries in the database. When images are added to an online book, the image file is uploaded to a central server and a user has the option of making the image public. If the image is made public, it is available to other users of the system in their books, without replicating the actual file or consuming more storage space. Regardless of how many people view books with a given picture, that picture need only be stored once. Additionally, contact sheets (described previously) of multiple private pictures can be sent to other system users, thereby giving them rights to use the represented images. Again, use of these images by other authors or in other books, does not require any additional storage of duplicate images.

Sending a RealeBook differs from the PC-based version, in that neither the book, its contents, nor the included images are actually transferred directly from the author to the reader. Instead, a reference to the book is sent by E-mail or added to the recipient's own account (if one exists). If and when the recipient actually views the book through a web browser, the pages are dynamically rendered as designed by the author and images are downloaded to temporary storage in the reader's computer. The interface of the RealeBooks site is similar to that of a typical e-mail client, including inbox, sent, drafts and compose areas for received books, sent books, books under constructions, and new books, respectively. Although the interface resembles that of an e-mail client, book content is never sent through SMTP or any other mail transfer protocol.

### B. Development of the Electronic Literary Work

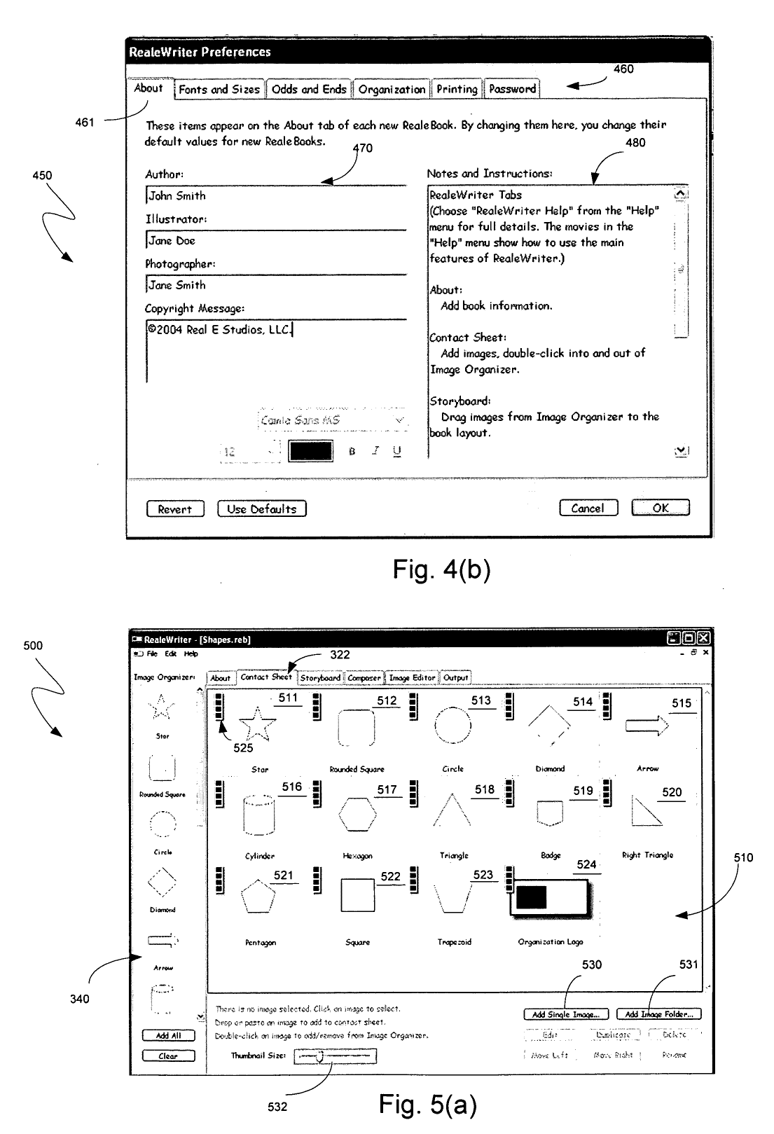

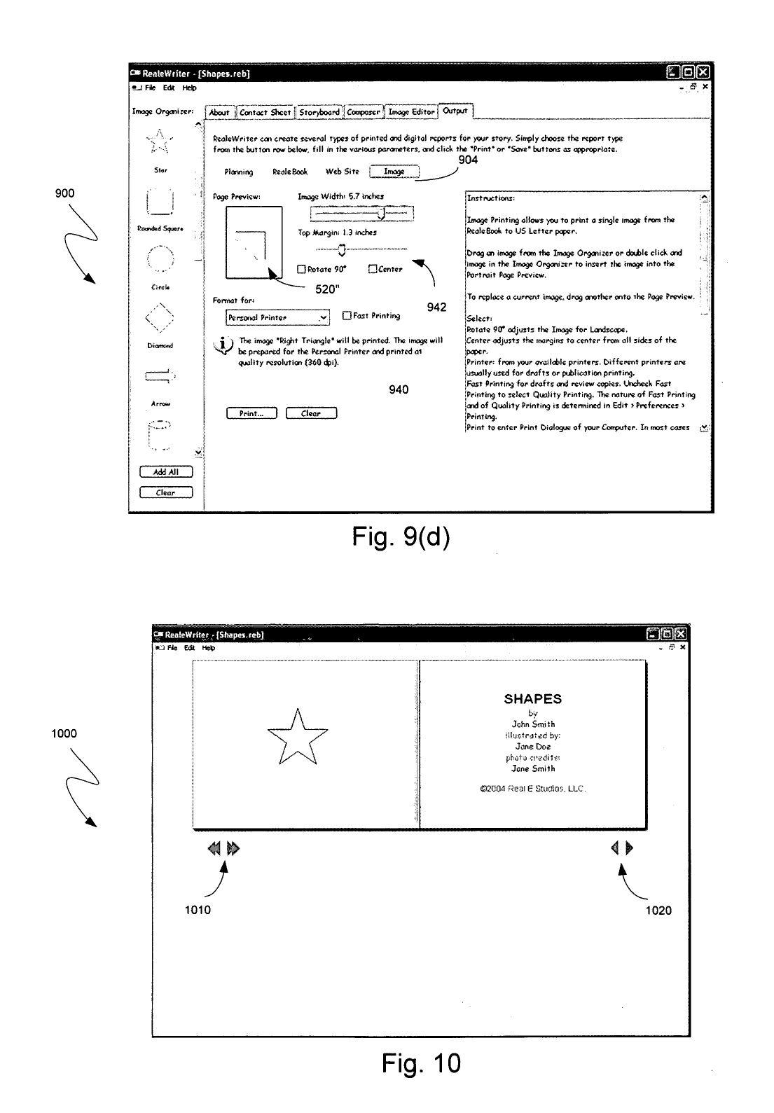

Having introduced possible environments for the present invention, reference is now made to FIGS. 3-9(d) to describe an exemplary embodiment for composition component 210. An exemplary embodiment for the viewing component will then be discussed with reference to FIGS. 10(a)-10(c). In preferred embodiments of the invention, these two components are integrated into a single application program which is executable on a user's computer system, although they could be separate.

The aspects of the present invention will be discussed as if the user, such as a student, were creating a digital book from scratch. However, it should be understood that the capabilities of the program permit a user to save his/her progress prior to completion of the work so that the various windows and steps discussed below can be accessed conveniently at any time. Furthermore, it should be readily appreciated also that the look and feel of the various program windows, i.e. the graphical user interfaces (GUIs), described below have been developed to be aesthetically pleasing to a user and emulate the visual appearance, and general physical experience of reading a traditional printed book.

Upon opening an appropriate application program which contains the composition and storage components, the user is initially presented with a main application or project window 310 as shown in FIG. 3. It is from this main application window that various capabilities are accessible so that the user can actually create the literary work by marrying images with text in a user-defined manner. It is also from this main application window 310 that the various other child windows, menus and options for the program are readily accessible. As shown in FIG. 3, main application window 300 includes various control items and icons conventionally found in many windows-based applications. Generally speaking, these items, when selected by an appropriate pointing device or keyboard stroke combination, provide the user with various capabilities for editing, importing, saving, etc. during operation of the program. As an example, application window 300 includes various standard menu items 310 from which many of these capabilities can be accessed. To the extent these various options and capabilities associated with the application program are well known, there is no need to discuss them herein.

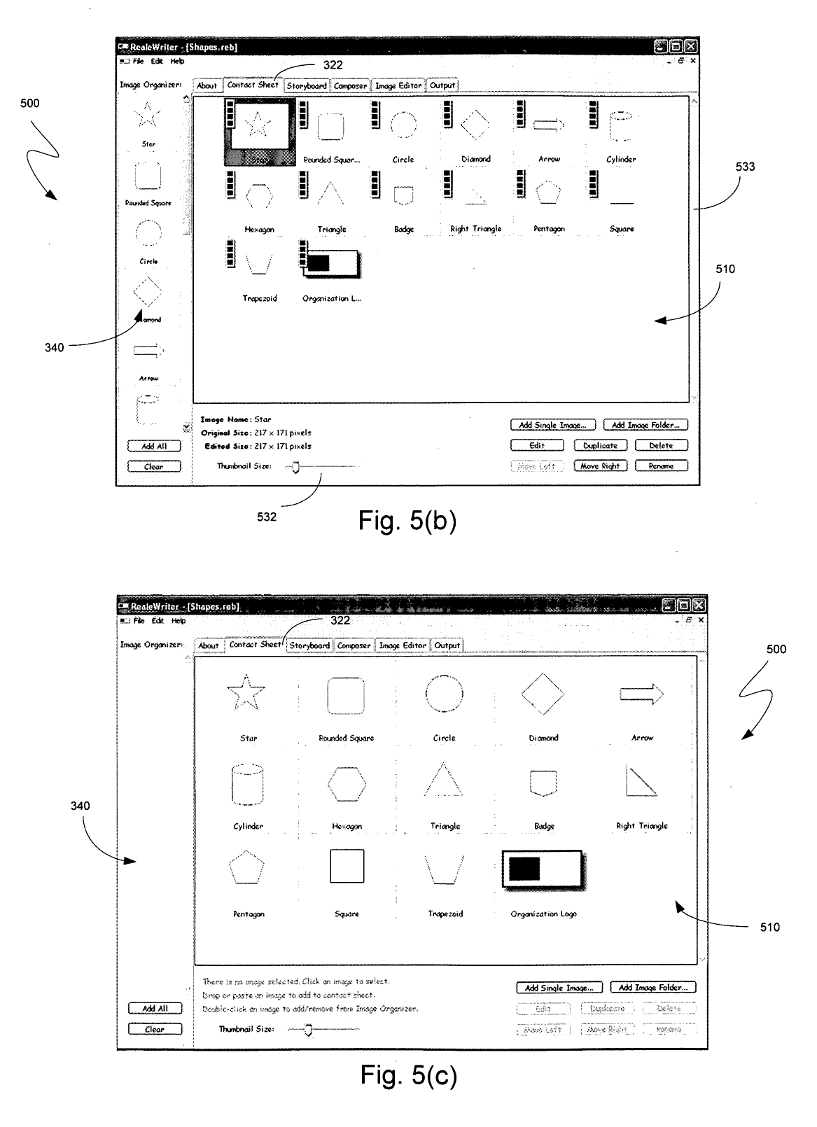

Brief reference is, however, made to FIGS. 4(a) and 4(b) which, respectively, show how various styles and preferences can be tailored by the user. With initial reference to FIG. 4(a), a dialog window 400 is shown which is accessible via the program's main menu 310. Dialog window 400 provides various controls for tailoring the default presentation of text and images. For example, text placement controls 410 are provided whereby the user can selectively adjust the default placement of text within a square grid of possible placement locations. The same holds true for images which have their own default control 420. Other standard control items, for example, in the form of list boxes, radio buttons, check box controls, and the like, collectively 430, are provided to selectively adjust the default format for text and images.

With reference to FIG. 4(b) another dialog window is accessible from the program's main menu 310 whereby the user can adjust various other preferences associated with the program. Dialog window 450 provides a tab panel control 460 to which various common application program settings can be adjusted. For illustrative purposes only one of these is shown in FIG. 4(b) which illustrates information presented to the user upon selection of the “About” tab control 461. Various text fields 470 are provided whereby the user can input appropriate identifying information corresponding to contributors to the work. Also conveniently provided as part of dialog window 450, as well as other windows throughout the program, is an informational window 480 within which the user can scroll to obtain instructional and help information corresponding to the currently active form. It can be noted that the same information within the various text boxes 470 of FIG. 4(b) are also presented to the user within text boxes 370 (FIG. 3) as part of the main project window 300 when its corresponding “About” tab 321 has been selected.

With reference, then, again to main project window 300 in FIG. 3, it too incorporates a tab panel 320 comprising various tab controls 321-326. The various capabilities associated upon selecting these various tabs 321-326 are described in the figures below. It can be appreciated, though, that a graphical user interface (GUI) is presented to the user as shown in the various figures. This GUI incorporates a composition menu, such as provided via tab control panel 320, having a set of entries 321-326 for the composition menu as shown. Selected ones of these entries, namely tabs 321-324, correspond to a selected development stage during preparation of the electronic literary work. It can be appreciated, then, that the program receives a respective composition menu entry selection signal which is indicative of the selection device, such as a mouse, pointing at a respective menu entry within composition menu 320.

Also presented to the user as part of indicative the main project window 300 is an image organizer panel 340 within which various thumbnails of images can be displayed.

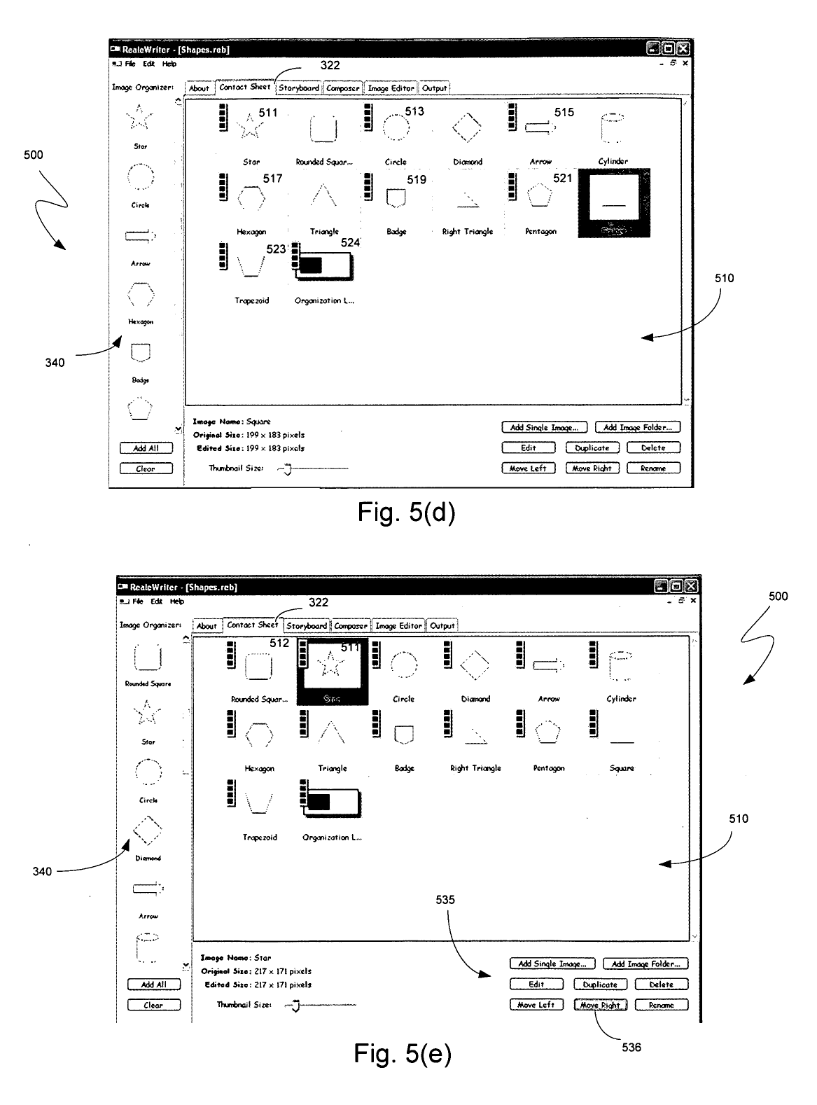

FIGS. 5(a)-5(e) illustrate various capabilities associated with creation of a contact sheet. Contact sheet window 500 is accessible upon selection of tab 322 in FIG. 3. Thus, when an appropriate pointing device or the like selects tab 322 of composition menu 320, a menu entry selection signal is received by the system and the program responds to this entry selection signal by displaying a first working area 510 which can be populated with digital images to produce a contact sheet view as shown in FIGS. 5(a)-5(e). FIG. 5(a) illustrates the first working area 510 populated with a plurality of digital image thumbnails 511-524 from an archive image set. For example, the user can navigate to the various images via selection of push button controls 530 or 531. More particularly, it is understood that various digital images can be stored locally on the computer system or remotely in a storage component such as one or more files, directories, etc. whereby the images can be navigated to and selected through known techniques. For each image which is imported and made active, this status can be indicated, for example, by appending an associated film reel icon to its thumbnail. Thus, FIG. 5(a) shows that each of the imported images 511-524 has an associated film reel icon appended thereto, such as icon 525 associated with image 511. As such, each of the thumbnails populating the first working area 510 is reproduced in the image organizer panel 340 to indicate that it has been selected as part of the literary work composition. As may also be seen in FIG. 5(a), the vertical ordering of the thumbnails in the image organizer panel 340 corresponds to the ordered arrangement of the thumbnails in first working area 510. For illustrative purposes, FIG. 5(b) shows that the size of the image thumbnails can be conveniently adjusted through a slider control 532. A vertical scroll bar 533 is also conveniently provided to scroll upwardly and downwardly through the imported image set.

FIG. 5(c) illustrates de-selection of all of the previously imported images from the archive image set such that their thumbnails do not include any film reel icon and no thumbnails are reproduced in the image organizer panel 340. Thus, in FIG. 5(c) the working image set is null. FIG. 5(d) illustrates a capability between these two extremes wherein the working image set comprises a sub-set of images 511, 513, 515, 517, 519, 521 and 523-524 that have been selected within first working area 510, such that image organizer panel 340 only displays these same images. Finally, FIG. 5(e) is provided to illustrate the ability to selectively reorder the images within the contact sheet window's first working area 510. This is accomplished via navigation control buttons 535, and FIG. 5(e) representatively illustrates how image 511 has been moved to the right one position so that it is now the second image presented in the sequence. This can be accomplished, for example, by highlighting the thumbnail 511 as shown and selecting the “move right” push button 536. A corresponding re-ordering of the thumbnails within the image organizer panel 340 also occurs as shown in FIG. 5(e).

While the various capabilities associated with the contact sheet window 500 have been described with reference to digital images in the form of various geometric representations, it should be readily appreciated by the ordinarily skilled artisan that the present invention contemplates any of a variety of digital image types, such as the graphic images as shown, digital photographs, scanned images or the like. Indeed, it is contemplated that the imported digital images could even be video clips with accompanying audio so they should not be unduly limited to “still” images. Furthermore, the capabilities of today's computer system should permit the imported set of digital images to comprise one or more suitable image types and formats based on the user's preferences.

The various images used can reside in folders or sub-folders elsewhere on the computer system and be conveniently loaded into the program via Windows® Explorer, the desktop, or any other location from which a folder may be accessed and dragged into the contact sheet sub-window 44. Necessarily, each file containing an associated image would be recursively checked to ensure that it is an appropriate type of graphic file (JPG, GIF, etc.), with other file types being ignored. Each graphic file corresponding to an associated image is optimized and resized, as necessary, with the resized image placed in a folder in the current working area. Once the various images in the image set have been placed in the working area of the contact sheet, they can be conveniently rearranged as desired through conventional drag and click operations.

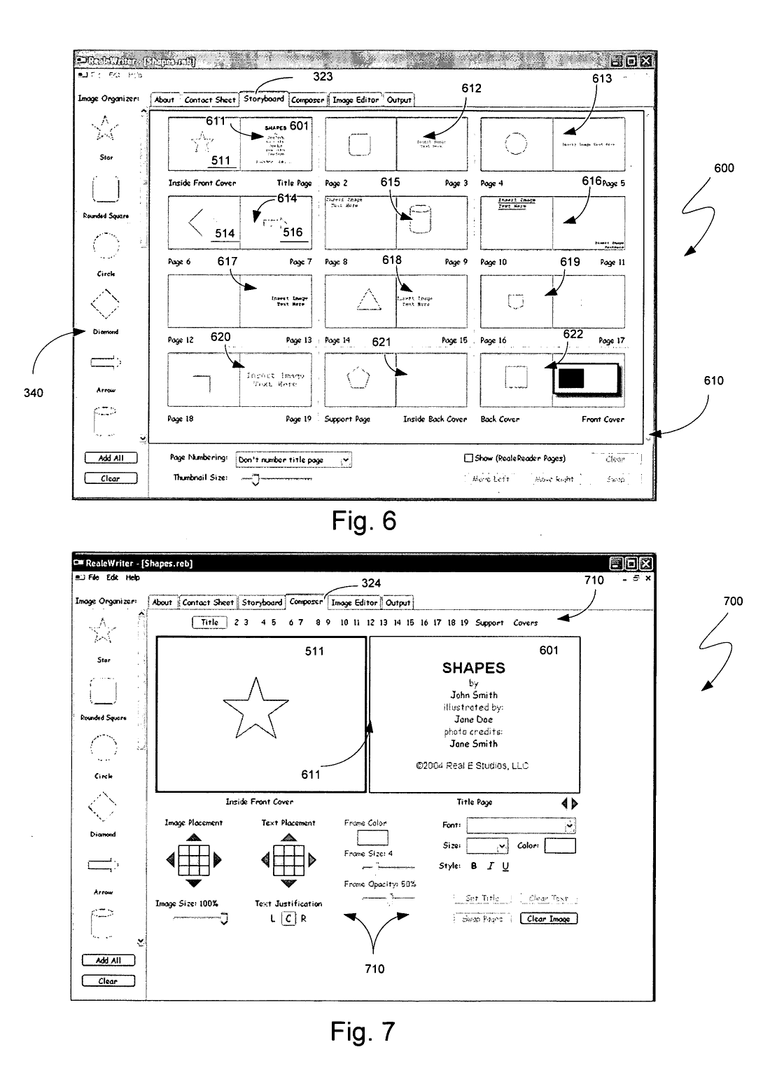

FIG. 6 illustrates a representative storyboard window 600 which may be displayed by the application program. Storyboard window 600 can be displayed, for example, upon receipt by the system a menu entry selection signal indicative of the selection device pointing at menu entry 323 of composition menu 320 (FIG. 3), which corresponds to a storyboard stage of development. It should be noted that the storyboard window 600 gets updated to reflect changes made to images and/or text in other areas of the program accessible. As such, FIG. 6 shows a representative storyboard for illustrative purposes only, and does not necessarily correlate to the various contact sheet views discussed earlier. In storyboard view 600 it may be seen that the program has populated a second window area 610 with a plurality of pairs of companion image items 611-622. In various ones of these companion image items, image data has been respectively associated with selected images from the working image set. Sequential page numbering has also been assigned to the items according to the storyboard sequence, as well as designations for the title page and various cover pages. Again, the image organizer panel 340 reveals those images within the storyboard view 600 which have been selected.

FIG. 6 reveals that the various pairs of companion image items 611-622 can have a variety of characteristics. It should be appreciated that FIG. 6 is more illustrative of the various capabilities for generating companion image items having various characteristics, rather than being a representative example of an actual storyboard. Indeed, where the electronic literary work is a recipe, for example, each of the pairs of companion image items could include a photograph showing a respective stage in the food preparation process, accompanied by a text description relating to the recipe. With the above in mind, each of companion image items 611-613, 615, and 617-620 is representatively characterized by an associated digital image from the contact sheet and respective image data in the form of text-only data. Representative companion image item pair 614, on the other hand, includes two digital images 514 and 516 some from the working image set. The same holds true for the companion image items 622. Representative still is companion image items 616 which are both text-only. Accordingly, it can be appreciated that respective image data can be associated with at least some or all of the digital images within the working image set from the contact sheet to define pairs of companion image items. Other companion image items can be generated which do not include digital images of any type. It should be appreciated that the respective image data that can be associated with some or all of the digital images from the working image set can be text-only data, non-text only or a mixture of text-only data and non-text only data.

Textual input can be multi-lingual if desired. That is, it is contemplated that the program can incorporate the option of selecting one or more languages to be used during its creation. Alternatively, a translator package could be integrated with the program to convert the text between languages. With this capability, the program becomes a language learning tool. For instance, the original work could be created in English, with the corresponding Spanish translation presented visually, audibly or otherwise, simply through the click of a mouse button. Moreover, as mentioned above, it should readily appreciated that any non-text data can be graphic images, photographic images, video images or appropriate mixtures of the same. In any event, FIG. 6 reveals some of these variations for illustrative purposes only.

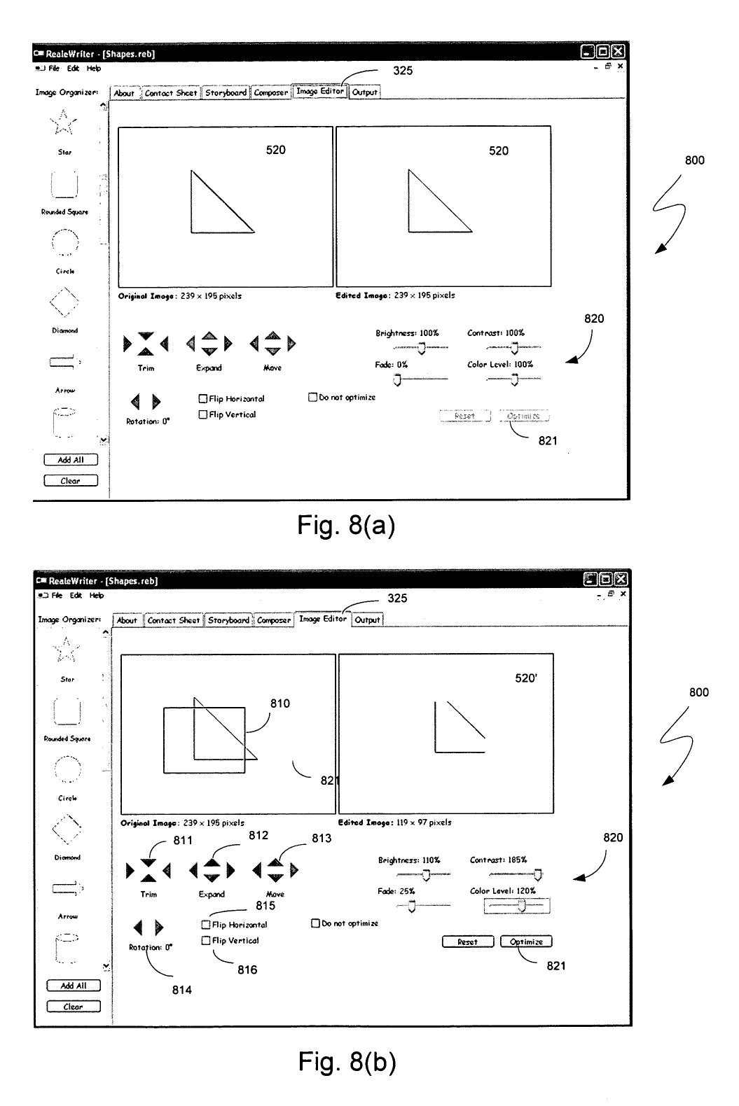

With reference now to FIG. 7, a composer window 700 can be presented upon selection of tab 324 in FIG. 3. Composer window 700 brings up a selected pair of companion image items, such as pair 611. Of course, the particular companion image items which are presented can be selected in a variety of manners. For example, if one of the pairs of companion image items is highlighted in FIG. 6, then subsequent selection of the composer tab 324 will cause it to be reproduced in window 700. Alternatively, composer window 700 conveniently provides selectable page pairs 710 so that the user can conveniently navigate through the various pages within the storyboard sequence and make adjustments to them within composer window 700.

To this end, FIG. 7 representatively shows companion image items 611 corresponding to the inside front cover which uses digital image 511 and the title page 621 which is text-only. Composer window 700 provides a set of selected image and text editing controls, collectively 710. Thus, for example, when image 511 is selected as revealed by its bolded periphery, various ones of these controls 710 become activated to permit the image to be placed within a desired grid location, permit the size of the image to be adjusted, or permit the image to be cleared altogether. It can be appreciated that various capabilities are also available when the text-only image data 621 is selected. Upon doing so, various other controls within control set 710 become activated to permit the style, format and location, etc. of the text 621 to be adjusted. Any changes made within the composer window 700, then, become reflected in the storyboard view 600 of FIG. 6. Having thus described FIG. 7, the reader should readily appreciate how the composer window can be used to derive the various companion image item presentations shown in the storyboard sequence of FIG. 6.

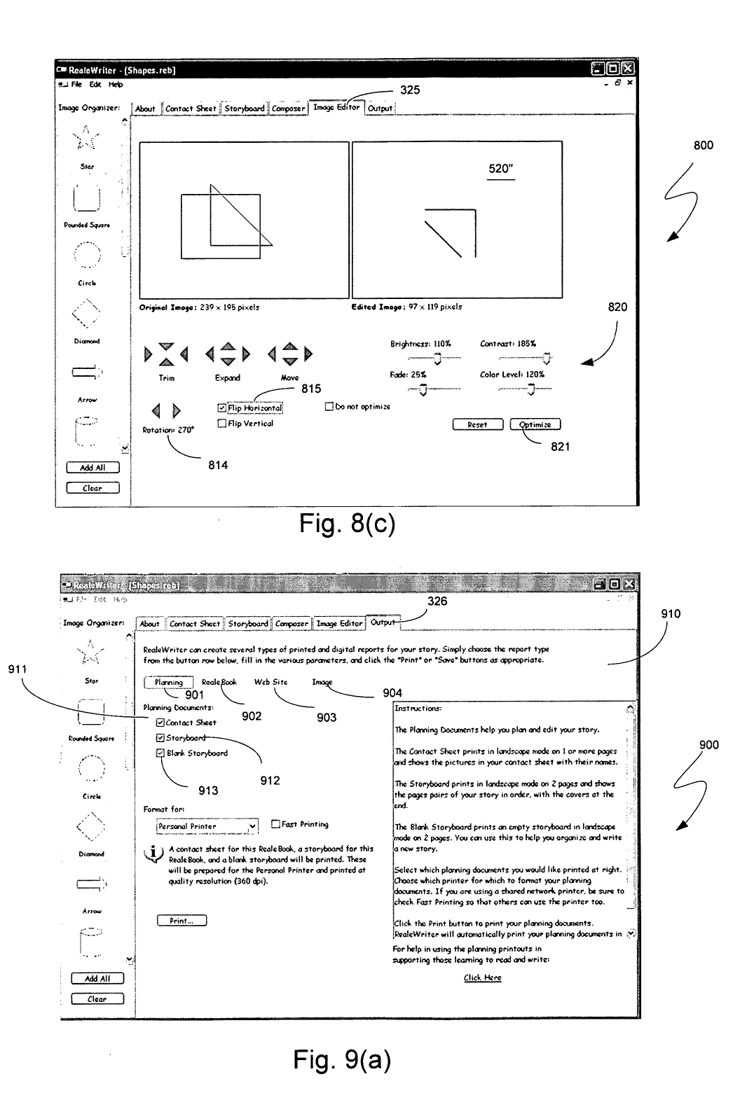

Additional editing capabilities representatively illustrated in FIGS. 8(a)-8(c) are accessible upon selection of the “image editor” tab 325. Doing so brings up image editor child window 800 whereby a selected image, such as image 520, can be altered. Prior to any alteration, the original and edited images are the same as shown in FIG. 8(a). If, however, it is desirable to edit the image, a selection box 810 is provided which can be trimmed, expanded and moved in four directions via controls 811-813. FIG. 8(b), thus, demonstrates how the selection box 810 can be used to generate a first edited image 520′ which is a cropped version of the original image 520. Thereafter, the cropped image 520′ can be rotated or flipped via controls 814-816 as desired. Thus, FIG. 8(c) shows another edited image 520″ which is generated by rotating edited image 520′ by 270° and flipping it horizontally via use of controls 814 and 815. As may also be seen in FIGS. 8(a)-8(c), the image editor window 800 includes slide controls 820 for adjusting other aspects of the image pertaining to brightness, contrast, fade and color level. Finally, an image optimization control 821 is provided to adjust a particular image to 320 pixels by 240 pixels, the precise proportions of the onscreen display. This feature is also present in the “File” pull down menu (not shown), from main menu 310 in FIG. 3, in order to optimize all images in the project. Further, it invites the user to remove any image in the contact sheet that has not been included in the project. Optimizing reduces the file size of the project making it a manageable size for storage or sharing electronically.

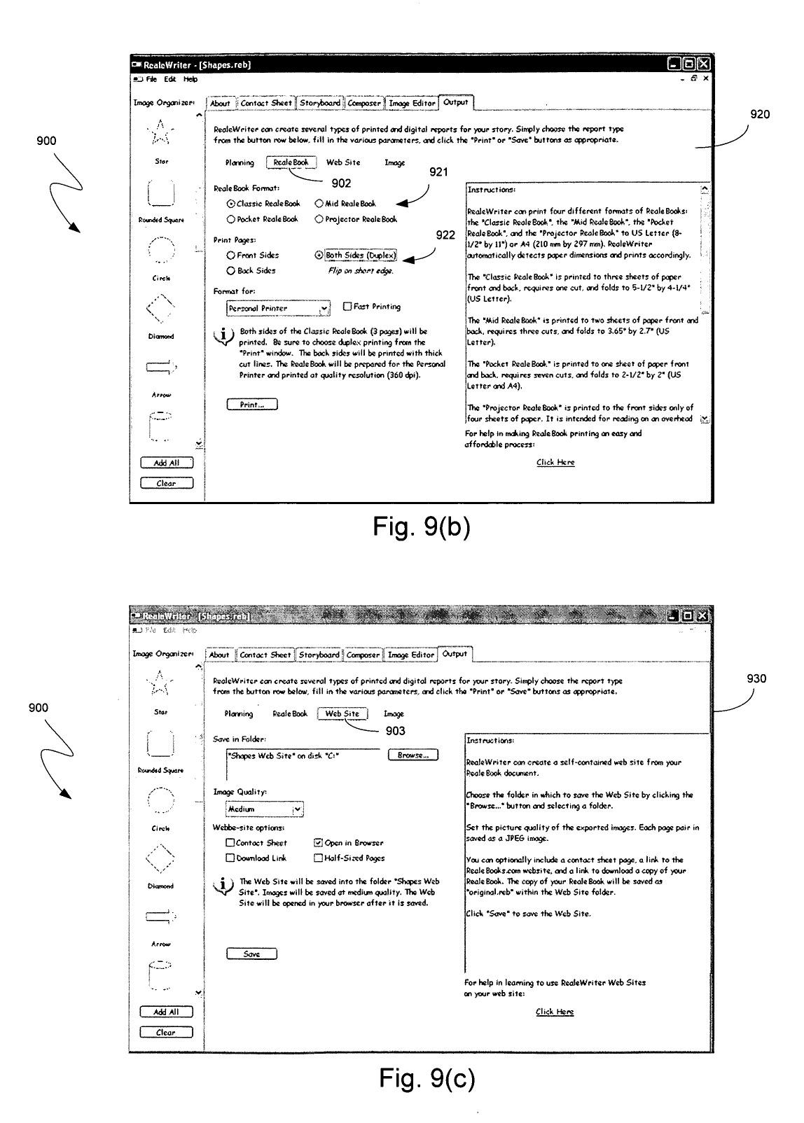

Once the storyboard for the electronic literary work has been finalized to the user's liking, output tab 326 can be selected from the application's main project window 300 in order to generate various types of output as illustrated in FIGS. 9(a)-9(d). Output window 900 can display various screens upon selection of push button controls 901-904. FIG. 9(a) shows a “planning” screen 910 presented upon selection of push button 901. Planning screen 910 allows the user to print various planning documents as determined by check box controls 911-913. Accordingly, selection of check box control 911 prints a contact sheet of the selected digital images within the working image set. Selection of check box control 912 prints an appropriate storyboard such as shown in FIG. 6, while selection of check box control 913 prints a blank storyboard to assist a user in creating a script.

A second screen 920 for output window 900 is accessible via push button control 902 which corresponds to the ability for a user to print the project in a book format, referred to as “Reale Book”. Selectable radio button controls 921 and 922 are provided so that the user can dictate the particular size and print format for the printed pages. The printing options permit the user to print a tangible, paper-form version of the electronic book which has been created. Each option preferably provides the capability of printing on either one or both sides of sheet(s) of paper which can then be appropriately cut if needed, collated and bound, through stapling or otherwise, into a conventional book form. FIG. 9(c) shows a third screen 930 associated with output tab window 900 which is revealed upon selection of the “Web Site” button 903. From this screen 930 the user is able to create a self-contained website from the stored document. This web site allows the user to link a project from any existing Internet site. The project displays in its own window and appears as shown in FIG. 10.

Finally, a fourth screen 940 for output tab window 900 is accessible upon selection of push button control 904 entitled “Image”. It is from this screen 940 that the user can optionally select to print a single image from the contact sheet. Selection of the image to be printed, such as edited image 520″ can be accomplished by double clicking the original image from the image organizer panel 340 or through a conventional drag and drop operation. In any event, once the particular image has been selected for printing, other adjustments can be made thereto via the self-explanatory set of controls 942 in FIG. 9(d).

Once the electronic literary work has been created through the composition component discussed in FIGS. 3-9(d), an e-book format for the work may be displayed through a suitable viewing component as discussed above. A representative e-book format illustrating the inside front cover page and the title page is shown in FIG. 10. A viewing window 1000 is displayed and this viewing window 1000 can be accessed, for example, via an appropriate menu item within the main program's file menu. As discussed earlier, though the viewing component could alternatively be separate from the composition component. The e-book displayed endeavors to emulate the experience of reading a conventional tactile, bound book. In FIG. 10, the inside front cover and the title page are shown which correspond to the companion image item pair 611 discussed above. Page navigation controls 1010 and 1020 are provided so that the reader can jump to the beginning or end of the book via controls 1010 or individually leaf through the pages via controls 1020.

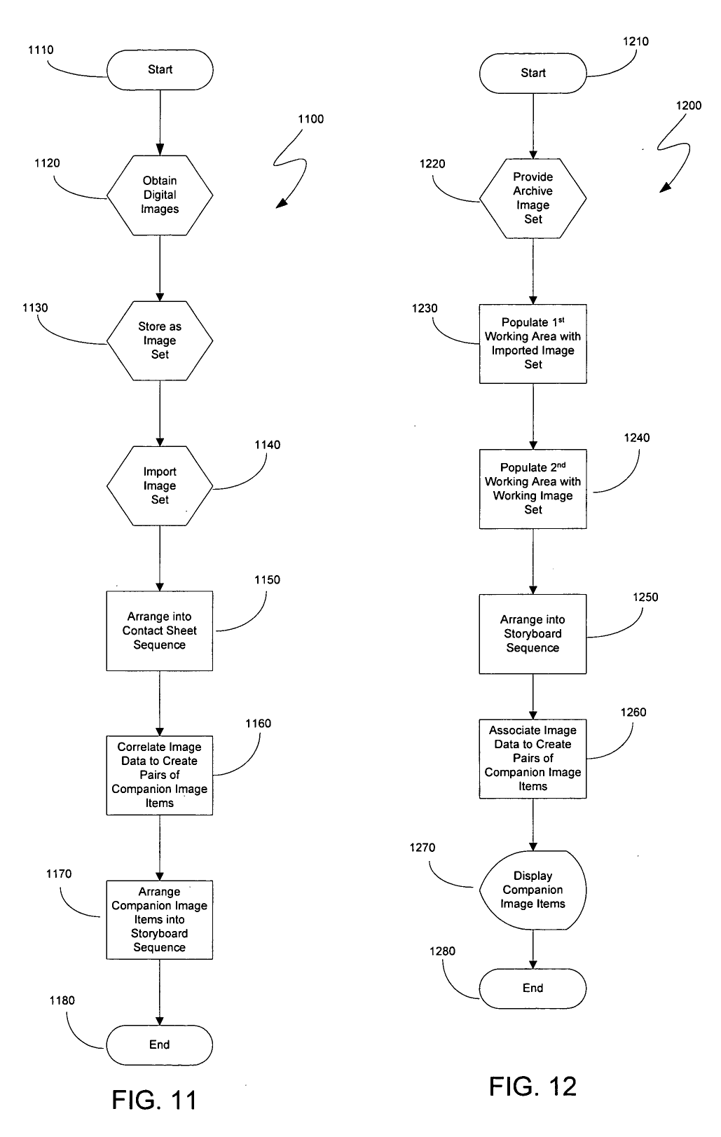

With the above in mind, a high level flowchart is shown in FIG. 11 for a first exemplary embodiment of a computerized method 1100 for creating an electronic literary work on a computer system. Following start 1110, digital images are obtained at 1120 and stored as an image set at 1130. These operations 1120 and 1130 can be accomplished in a variety of ways as should be readily apparent to the skilled artisan. For example, digital images can be obtained at 1120 through a suitable digital camera and stored at 1130 at an appropriate location on a user's computer system. Alternatively, as discussed above the digital images can be obtained from a remote location and stored locally. Some or all of these images, referred to as an “image set” are imported at 1140 and arranged into a contact sheet sequence at 1150. At 1160 in FIG. 11, image data is correlated to some or all of the images within the imported image set to create pairs of companion image items. The companion image items are optionally arranged into a storyboard sequence at 1170, should the sequence of images for the story differ from the order in which they were imported, after which methodology 1100 ends at 1180.

A second exemplary embodiment for computerized method 1200 is shown in FIG. 12. Following start 1210, an archive image set is provided at 1220 and a first working area is populated at 1230 with an imported image set that is derived from the archive image set. A second working area 1240 is populated with a working image set that is derived from the imported image set. The working image set is arranged into a selected storyboard sequence at 1250, and image data is associated with one or more of the images within the working image set at 1260 to create pairs of companion image items. These companion image items are then displayed at 1260, and methodology 1200 then ends at 1280.

Accordingly, the present invention has been described with some degree of particularity directed to the exemplary embodiments of the present invention. It should be appreciated, though, that the present invention is defined by the following claims construed in light of the prior art so that modifications or changes may be made to the exemplary embodiments of the present invention without departing from the inventive concepts contained herein.

1. A computerized method for creating an electronic literary work on a computer system that includes a display, said computerized method comprising:
(a) providing an archive image set which includes a plurality of digital images;
(b) populating a first working area of an application program with selected digital images from the archive image set, thereby to generate a contact sheet view comprising an imported image set;
(c) populating a second working area of the application program with selected digital images from the imported image set, thereby establishing a working image set;
(d) arranging the digital images which comprise said working image set into a selected storyboard sequence;
(e) associating respective image data with at least some of the digital images in said working image set, thereby to define pairs of companion image items; and
(f) displaying the pairs of companion image items on the display according to said storyboard sequence.

2. A computerized method according to claim 1 whereby said archive image set is stored locally on the computer system.

3. A computerized method according to claim 1 whereby said archive image set is stored remotely on a remote computer system that is accessible through a suitable communications interface.

4. A computerized method according to claim 1 whereby said first and second working areas are different child windows of the application program.

5. A computerized method according to claim 1 whereby those digital images which populate both said first working area and said second working area appear in a common ordered arrangement.

6. A computerized method according to claim 1 whereby said working image set and said imported image set are the same.

7. A computerized method according to claim 1 whereby the respective image data is selected from a first group of data types consisting of text-only data, non-text data, and a mixture of text-only data and non-text data.

8. A computerized method according to claim 7 whereby said non-text data is selected from a second group of data types consisting of graphic images, photographic images and a mixture of graphic images and photographic images.

9. A computerized method according to claim 8 whereby respective image data is associated with each of the digital images in said working image set.

10. A computerized method according to claim 1 whereby the pairs of companion image items are displayed as an electronic book.

11. A computerized method according to claim 1 whereby the archive image set and the imported image set are the same.

12. A computerized method according to claim 1 comprising generating a front cover and a back cover for the electronic literary work by utilizing at least one selected digital image from said archive image set.

13. A computerized method according to claim 1 whereby the respective image data associated with each of the digital images is text-only data.

14. A computerized method according to claim 1 comprising associating a page number to each item within each of the pairs of companion image items, thereby to generate a numerical page sequence which chronologically corresponds to the selected storyboard sequence.

15. A computerized method for creating an electronic literary work, comprising:
(a) obtaining a plurality of digital images;
(b) storing said digital images on a storage device as an image set;
(c) importing the image set from the storage device into a working project area of a display device, thereby populating the working project area with said digital images;
(d) arranging said digital images into a selected contact sheet sequence;
(e) correlating respective image data with each of said digital images, thereby to define pairs of companion image items; and
(f) arranging the pairs of companion image items into a selected storyboard sequence whereby the pairs of companion image items may be selectively displayed according to the selected storyboard sequence.

16. A computerized method according to claim 15 whereby said image set is stored locally on the computer system.

17. A computerized method according to claim 15 whereby said image set is stored remotely on a remote computer system that is accessible through a suitable communications interface.

18. A computerized method according to claim 15 whereby the respective image data is selected from a first group of data types consisting of text-only data, non-text data, and a mixture of text-only data and non-text data.

19. A computerized method according to claim 15 comprising associating a page number to each item within each of the pairs of companion image items, thereby to generate a numerical page sequence which chronologically corresponds to the selected storyboard sequence.

20. A computer-readable medium having executable instructions for performing a method comprising:
(a) providing an archive image set which includes a plurality of digital images;
(b) populating a first working area of an application program with selected digital images from the archive image set, thereby to generate a contact sheet view comprising an imported image set;
(c) populating a second working area of the application program with selected digital images from the imported image set, thereby establishing a working image set;
(d) arranging the digital images which comprise said working image set into a selected storyboard sequence;
(e) associating respective image data with at least some of the digital images in said working image set, thereby to define pairs of companion image items; and
(e) controlling an output device to display said pairs of companion image items on a display medium according to said storyboard sequence.

21. A computer-readable medium having executable instructions according to claim 20 whereby each of said first working area and said second working area is a respective child window of the application program.

22. A computer-readable medium having executable instructions according to claim 20 whereby the respective image data is selected from a first group of data types consisting of text-only data, non-text data, and a mixture of text-only data and non-text data.

23. A computer-readable medium having executable instructions according to claim 20 whereby respective image data is associated with each of the digital images in said working image set.

24. A computer-readable medium having executable instructions according to claim 20 whereby the pairs of companion image items are displayed as an electronic book.

25. A computer-readable medium having executable instructions according to claim 20 for generating a front cover and a back cover for the electronic literary work by utilizing at least one selected digital image from said archive image set.

26. A computer-readable medium having executable instructions according to claim 20 for associating a page number to each item within each of the pairs of companion image items, thereby to generate a numerical page sequence which chronologically corresponds to the selected storyboard sequence.

27. A computer-readable medium having executable instructions according to claim 20 for printing selected ones of the pairs of companion items according to a selected print sequence.

28. A system for enabling creation and viewing of an electronic literary work, said system comprising:
(a) a composition component for creating the electronic literary work, said composition component including editing capabilities which permit user-defined image data to be respectively associated with each of a plurality a digital images, thereby to define pairs of companion image items which may be arranged according to a selected storyboard sequence;
(b) a storage component for storing an archive set of digital images for retrieval by said composition component; and
(c) a viewing component for enabling the electronic literary work created by said composition component to be viewed according to said storyboard sequence.

29. A system according to claim 28 wherein said composition component and said storage component reside on a common computer system.

30. A system according to claim 29 wherein said composition component and said viewing component are part of a common application program.

31. A system according to claim 28 wherein said composition component and said storage component reside on different computer systems.

32. A system according to claim 31 wherein said storage component is located on a remote computer system from said composition component, and including a suitable communications interface for accessing said storage component.

33. A system according to claim 28 wherein the user-defined image data is selected from a first group of data types consisting of text-only data, non-text data, and a mixture of text-only data and non-text data.

34. A system according to claim 33 wherein said non-text data is selected from a second group of data types consisting of graphic images, photographic images and a mixture of graphic images and photographic images.

35. A system according to claim 28 wherein said viewing component enables the electronic literary work to be displayed as an electronic book.

36. A system according to claim 28 wherein each of said composition component, said storage component and said viewing component is at a distinct, remote location from one another, and including suitable communications interfaces for enabling data transmission therebetween.

37. A system for use in creating an electronic literary work, comprising:
(a) a storage device for storing a plurality of digital images as an archive image set;
(b) a display device;
(c) an output device; and
(d) a processor programmed to:
(i) retrieve an imported image set of digital images from said storage device;
(ii) generate a contact sheet view from the imported image set by populating a first working area of said display device with at least some of said plurality of digital images, thereby to define a working image set;
(iii) generate a storyboard view by arranging digital images within the working image set into a selected storyboard sequence on said display device;
(iv) associate respective image data with at least some of the digital images in said storyboard viewing sequence, thereby to define pairs of companion image items; and
(v) control at least one of said display device and said output device to display said pairs of companion image items to the storyboard sequence.

38. A system according to claim 37 wherein the respective image data is selected from a first group of data types consisting of text-only data, non-text data, and a mixture of text-only data and non-text data.

39. A system according to claim 38 wherein said non-text data is selected from a second group of data types consisting of graphic images, photographic images and a mixture of graphic images and photographic images.

40. A system according to claim 37 wherein said processor is programmed to display the pairs of companion image items as an electronic book.

41. A system according to claim 37 wherein said processor is programmed to associate a page number to each item within each of the pairs of companion image items, thereby to generate a numerical page sequence which chronologically corresponds to the selected storyboard sequence.

42. A system for use in creating an electronic literary work, comprising:
(a) storage means for storing a plurality of digital images as an archive image set;
(b) display means;
(c) output means; and
(d) processing means operative to:
(i) retrieve an imported set of the digital images from said storage means;
(ii) generate a contact sheet view from imported image set by populating a first working area of said display means with at least some of said plurality of digital images, thereby to define a working image set;
(iii) generate a storyboard view by arranging digital images with the working image set into a selected storyboard viewing sequence on said display means;
(iv) associate respective image data with at least some of the digital images in said storyboard viewing sequence, thereby to define pairs of companion image items; and
(v) control at least one of said display means and said output means to display said pairs of companion image items to the storyboard viewing sequence.

43. An electronic literary work produced by a method comprising:
(a) providing an archive image set which includes a plurality of digital images;
(b) populating a first working area of an application program with selected digital images from the archive image set, thereby to generate a contact sheet view comprising an imported image set;
(c) populating a second working area of the application program with selected digital images from the imported image set, thereby establishing a working image set;
(d) arranging the digital images which comprise said working image set into a selected storyboard sequence;
(e) associating respective image data with at least some of the digital images in said working image set, thereby to define pairs of companion image items; and
(f) displaying the pairs of companion image items on the display according to said storyboard viewing sequence.
